(19) United States
(12) Patent Application Publication
(10) Pub. No.: US 2010/0235328 A1
(43) Pub. Date: Sep. 16, 2010

(54) METHOD AND APPARATUS FOR TRACKING CONTENT PLAYBACK

(75) Inventors: Jari Pekka SUKANEN, Espoo (FI); Ari Tapani Koli, Helsinki (FI); Tero Antero Laiho, Helsinki (FI); Jukka Kalervo Immonen, Espoo (FI); Toni Laine, Helsinki (FI); Apaar Tuli, Helsinki (FI)

Correspondence Address: DITTHAVONG MORI & STEINER, P.C., 918 Prince Street, Alexandria, VA, 22314, US

(73) Assignee: Nokia Corporation, Helsinki (FI)

(21) Appl. No.: 12/401,038

(22) Filed: Mar. 10, 2009

(51) Int. Cl. G06F 7/00; G06F 17/30; H04B 1/40

(52) U.S. Cl. 707/665; 455/74

(57) ABSTRACT

An approach is provided for tracking played content that includes determining whether elapsed play time for particular content is greater than a threshold duration. Based on the determination that elapsed play time is greater than the threshold duration, data is stored. The data indicates the particular content is to be indicated in a list of played content.

### BACKGROUND

Content sharing applications have been one of the most widely used and popular applications over the Internet. At the same time, the use of wireless communication devices has become pervasive, and is rapidly overtaking the use of traditional wired devices. For example, one popular area involves the sharing of audio files and the generation and sharing of playlists. Traditionally, the creation of such playlists has unnecessarily consumed network resources. Because network resources, particularly in bandwidth-constrained systems such as wireless networks, are scarce, designing a proper mechanism for implementing such content sharing is vital.

### SOME EXAMPLE EMBODIMENTS

Therefore, there is a need, when forming a playlist for a user, to determine content played for sufficient time as to be indicative of the user's desire for the content to be included in the playlist.

According to one embodiment, a computer-readable storage medium carries instructions which, when executed by a processor, cause the one or more processors to at least perform the step of determining whether elapsed play time for particular content is greater than a threshold duration. The one or more processors are caused to perform steps further comprising, based on the determination that elapsed play time is greater than the threshold duration, initiating storage of data that indicates the particular content is to be indicated in a list of played content.

According to another embodiment, an apparatus comprises a processor and a memory storing executable instructions that if executed cause the apparatus to determine whether elapsed play time for particular content is greater than a threshold duration. The processor and memory are also configured to, based on the determination that elapsed play time is greater than the threshold duration, initiate storage of data that indicates the particular content is to be indicated in a list of played content.

According to another embodiment, a method comprises determining whether elapsed play time for particular content is greater than a threshold duration. The method also comprises based on the determination that elapsed play time is greater than the threshold duration, initiating storage of data that indicates the particular content is to be indicated in a list of played content.

According to another embodiment, a computer-readable storage medium carries instructions which, when executed by a processor, cause the one or more processors to at least perform initiating playing first content selected by a user. The one or more processors are caused to perform steps further comprising initiating sending, to a content tracking service, first event data that indicates the first content and a start time at which play of the first content began. The one or more processors are caused to perform steps further comprising initiating sending, to the content tracking service, second event data that indicates second content and a later time for play of the second content.

According to another set of embodiments, an apparatus comprises a processor and a memory storing executable instructions that if executed cause the apparatus to initiate playing first content selected by a user. The processor and memory are also configured to initiate sending, to a content tracking service, first event data that indicates the first content and a start time at which play of the first content began. The processor and memory are also configured to initiate sending, to the content tracking service, second event data that indicates second content and a later time for play of the second content.

According to yet another embodiment, a method comprises initiating playing first content selected by a user. The method also comprises initiating sending, to a content tracking service, first event data that indicates the first content and a start time at which play of the first content began. The method further comprises initiating sending, to the content tracking service, second event data that indicates second content and a later time for play of the second content.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system for tracking played content, according to one embodiment;

FIG. 1B is a diagram of components of a content service module, according to one embodiment;

FIG. 2 is a flowchart of a process for generating events on a content playing device, according to one embodiment;

FIG. 3 is a diagram of a play event message, according to one embodiment;

FIG. 4 is a flowchart of a process for tracking played content in the content service module, according to one embodiment;

FIG. 5 is a flowchart of a process for forwarding event messages in a message service module, according to one embodiment;

FIG. 6A is a time sequence diagram that illustrates a sequence of messages and processes for forwarding events, according to one embodiment;

FIG. 6B is a time sequence diagram that illustrates a sequence of messages and processes for requesting stored playback events, according to one embodiment;

FIG. 6C is a time sequence diagram that illustrates a sequence of messages and processes for marking stored events, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a terminal that can be used to implement an embodiment of the invention.

### DETAILED DESCRIPTION OF EXAMPLE EMBODIMENTS

A method, apparatus, and software for tracking content playback are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although several embodiments of the invention are discussed with respect to music (audio) playback at different devices in communication with a network, it is recognized by one of ordinary skill in the art that the embodiments of the inventions have applicability to any type of content playback (e.g., video and games) involving any device (e.g., wired and wireless local device or both local and remote wired or wireless devices) capable of playing content, or capable of communication with such a device. As used herein, content includes digital sound, digital images, digital games, and digital videos (such as music videos, news clips and theatrical videos) and any other digital media.

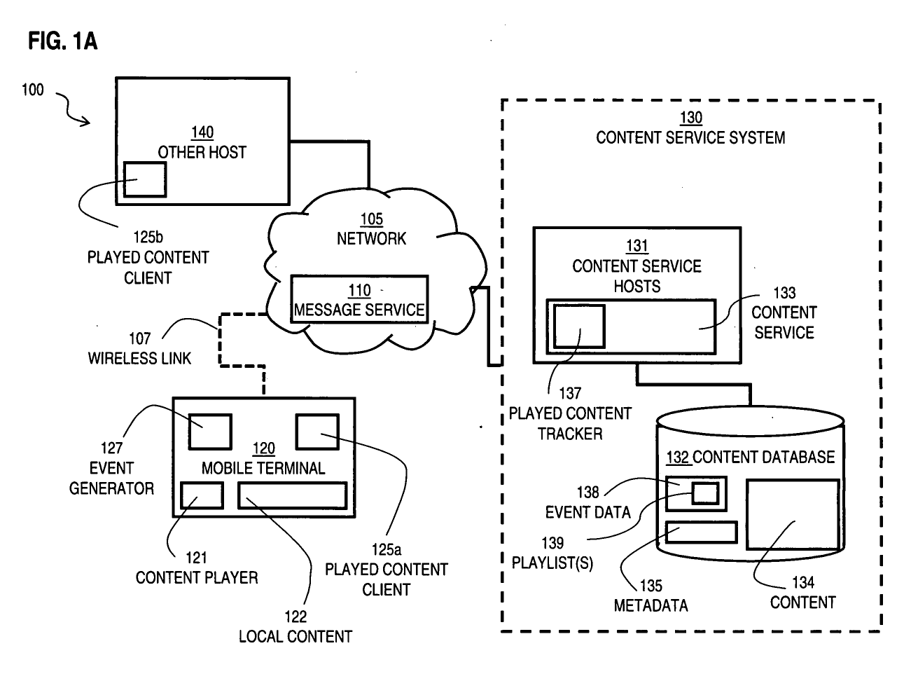

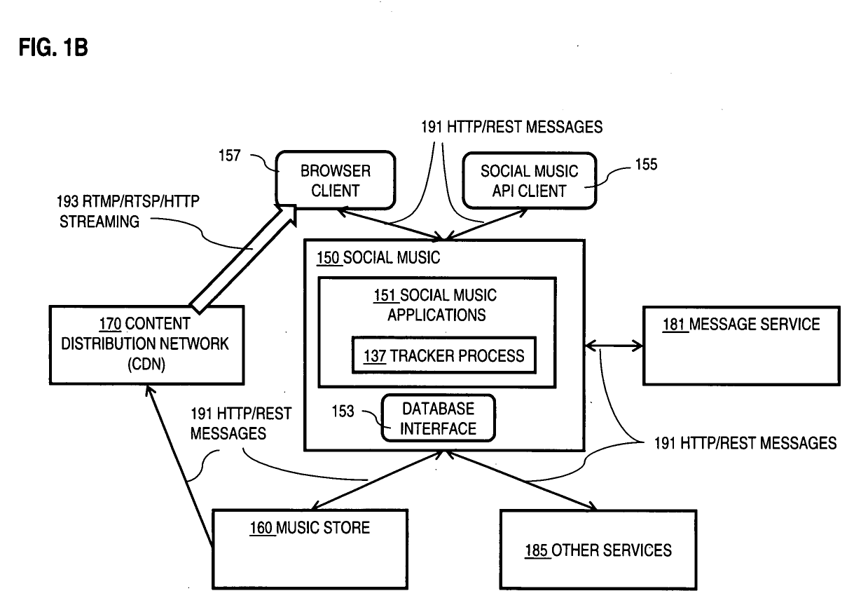

FIG. 1A is a diagram of a system for tracking played content, according to one embodiment. As shown in FIG. 1A, a system 100 includes a content service system 130 and a plurality of nodes (e.g., nodes 120, 131, 140) having connection with each other through a communication network 105. The system 100 utilizes metadata to facilitate efficient content storage and playlist generation. An important aspect of content sharing is identifying the content to be downloaded to a local wired or wireless device, and finding a source for that content on the network that is available to the local device. Another important aspect of content sharing is transferring a list of content available or played on one local or remote device to another local or remote device, often using a network available to both. For example, the transfer of such lists enables a user to move music listened to on one device, such as a portable MP3 player, to another device, such as a personal computer, so that the user can select from that list to burn a compact disc (CD) or Digital Versatile Disc (DVD, also called a or Digital Video Disc) with the user's favorite music. Similarly, a user can share a list of favorites with a friend or acquaintance.

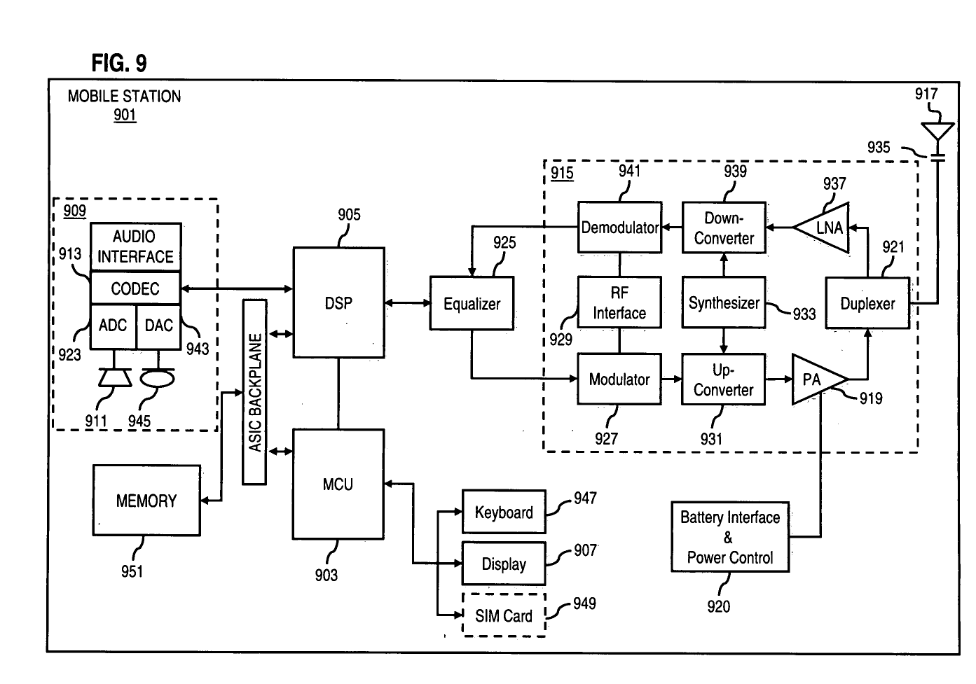

In various embodiments, nodes 120, 131, 140 can be any type of fixed terminal, mobile terminal, or portable terminal including desktop computers, laptop computers, handsets, stations, units, devices, multimedia tablets, Internet nodes, communicators, Personal Digital Assistants (PDAs), or any combination thereof. Moreover, the nodes may have a hard-wired energy source (e.g., a plug-in power adapter), a limited energy source (e.g., a battery), or both. It is further contemplated that the nodes 120, 131, 140 can support any type of interface to the user (such as “wearable” circuitry, etc.). In the illustrated embodiment, node 120 is a wireless mobile terminal (also called a mobile station and described in more detail below with reference to FIG. 9). The mobile terminal 120 is connected to network 105 by a wireless link 107.

By way of example, the communication network 105 of system 100 can include one or more networks such as a data network (not shown), a wireless network (not shown), a telephony network (not shown), or any combination thereof, each comprised of zero or more nodes. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including code division multiple access (CDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, wireless fidelity (WiFi), satellite, and the like. In various embodiments, communication network 105, or portions thereof, can support communication using any protocol, for example, the Internet Protocol (IP).

Information is exchanged between network nodes of system 100 are according to one or more of many protocols (including, e.g., known and standardized protocols). In this context, a protocol includes a set of rules defining how the nodes interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model. The OSI Reference Model is generally described in more detail in Section 1.1 of the reference book entitled “Interconnections Second Edition,” by Radia Perlman, published September 1999.

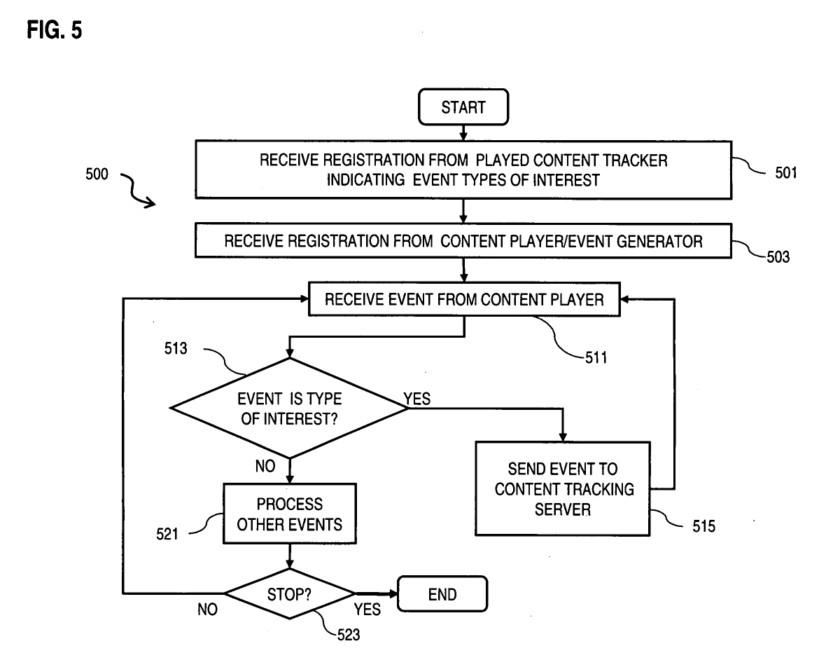

As shown in FIG. 1A, network 105 includes a message service process 110 operating on one or more nodes of the network 105. The operation of message service process 110 is described in greater detail below with reference to FIG. 5.

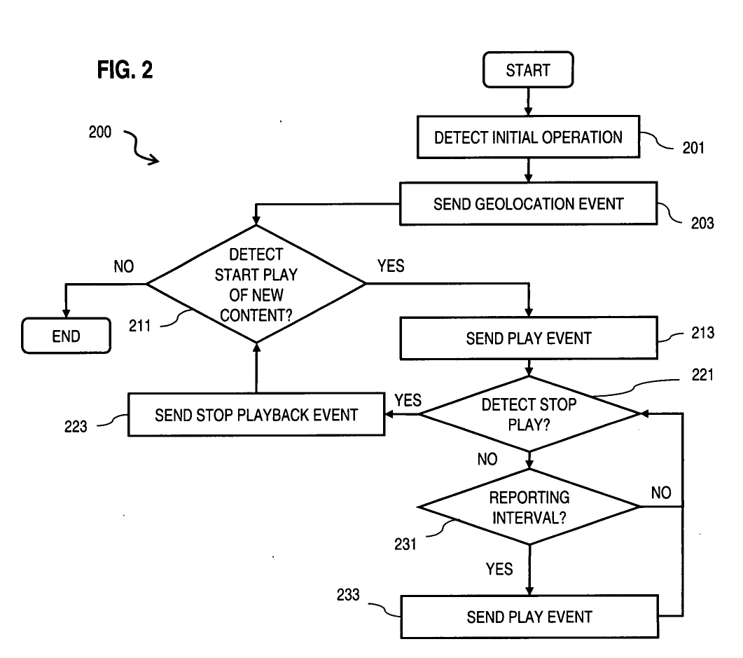

The mobile terminal 120 includes a data structure with local content 122, and a content player process 121 and an event generator process 127. The content player process 121 is operative to play content from the local content data structure 122 in response to input by a user. According to the illustrated embodiment, the mobile terminal includes event generator 127 that sends event messages over the network 105 based on the operation of content player process 121. The operation of event generator 127 is described in greater detail below with reference to FIG. 2.

In some embodiments, the mobile terminal includes played content client 125a, a process that obtains information about played content from content service system 130. In the illustrated embodiment, other host 140 includes a played content client 125b.

The content service system 130 includes one or more content service hosts 131 and a content database 132. The content service hosts are connected directly or indirectly to network 105. The content database 132 resides on one or more nodes connected directly or indirectly to the content service hosts 131, and it is anticipated that, in some embodiments, content database 132 resides on one or more nodes in network 105. The content database 132 includes one or more processes (not shown) and one or more data structures, including one or more content data structures 134 that store content, and a metadata data structure 135 that sores information about the content. In the illustrated embodiment, the content database 132 includes an event data structure 138 that stores information about played content events. In the illustrated embodiment, the event data structure 138 includes playlists data structure 139 that holds data that indicates what content has been played by each of one or more users on one or more nodes of system 100.

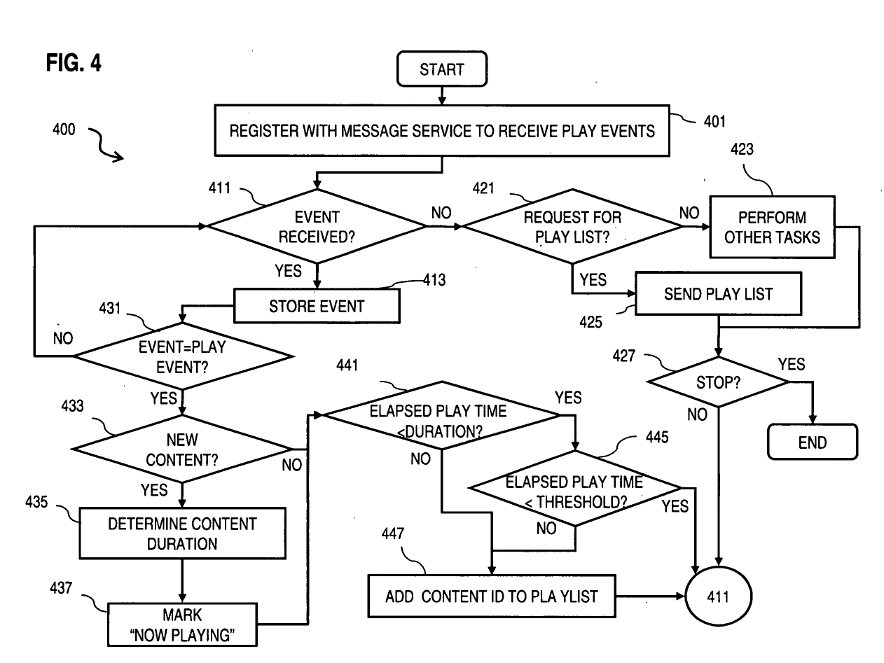

The content service hosts 131 are one or more nodes that support the content service module 133. The content service module 133 is a process that supports users in finding and playing content on their local devices in communication with the network 105. In the illustrated embodiment, the content service module 133 includes a played content tracker process 137, the operation of which is described in greater detail below with reference to FIG. 4.

In many networks, communications between nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

The client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

Although a particular set of nodes, processes, and data structures are shown in FIG. 1A for purposes of illustration, in various other embodiments more or fewer nodes, processes and data structures are involved. Furthermore, although processes and data structures are depicted as particular blocks in a particular arrangement for purposes of illustration, in other embodiments each process or data structure, or portions thereof, may be separated or combined or arranged in some other fashion. For example, in some embodiments, event generator process 127 is included within content player process 121; and, in some embodiments, played content tracker 137 is a separate parallel process from content service process 133.

FIG. 1B is a diagram of components of a content service module of the content service system, according to one embodiment. FIG. 1B also shows interaction between the content service module (e.g., content service process 133) and other processes on a network.

In the illustrated embodiment, the content service module is called Social Music module 150 and supports users in finding and playing music on their local devices in communication with the network. The Social Music module 150 includes a Social Music services 151 and a database interface process 153. The Social Music services are a set of applications (e.g., a Java™ stack written in the Java™ programming language that can be installed and executed on any device that includes a Java™ virtual machine (JVM) process). The Social Music services include instructions for finding metadata about songs and using the metadata to direct users to resources on the network where the user can purchase or download those songs, or both. The database interface process 153 is the interface between the Social Music module 150 and the content database 132; and is used to retrieve and store metadata, and to retrieve and store content.

In the illustrated embodiment, the Social Music services include played content tracker process 137 to track played content and to use the DB interface process 153 to store and retrieve the event data that describes what is being played and when.

The Social Music module 150 interacts with other processes on the network (e.g., network 105) using the hypertext transfer protocol (HTTP), often in concert with the Representational State Transfer (REST) constraints. The other processes may be on the same node or on different nodes.

In the illustrated embodiment, a user's device (e.g., mobile terminal 120 or other host 140) includes a Social Music application program interface (API) client 155 to interact with the Social Music module 150, and a browser client 157 to interact with World Wide Web pages using HTTP. The Social Music module 150 interacts with one or more Music Store systems 160, such as the NOKIA™ Music Store, to purchase songs to be downloaded to a user's device. The download is often accomplished using a Content Distribution Network (CDN) 170. The music store authorizes the CDN 170 to download to the client and then directs a link on the user's browser client 157 to request the content from the CDN 170. The content is delivered to the user through the user's browser client 157 as data formatted, for example, according to HTTP or the real-time messaging protocol (RTMP) or the real-time streaming protocol (RTSP), all well known in the art. As a result, the content is stored as local content 122 on user's device (e.g., mobile terminal 120) The local content 122 arrives on the mobile terminal 120 either directly from the CDN 170, or indirectly through some other device, e.g., a wired node like other host 140, using a temporary connection (not shown) between mobile terminal 120 and other host 140.

In some embodiments, the Social Music module 150 uses a message service 181 (such as the MICROSOFT YUKON service), to receive event data about playback events on the user's device. In some embodiments, the Social Music module 150 uses other services 185 available on the network (e.g., network 105) such as people services to connect with other persons in a Social Music group of persons, map services to show a user's location and points of interest on a map, and game services to determine the user's status in one or more games.

According to the illustrated embodiment, a system of processes to record and share a user's playlist begins with the event generator process 127 on a user device, such as mobile terminal 120. FIG. 2 is a flowchart of a process 200 for generating events on a content playing device, according to one embodiment. Although steps in FIG. 2 and subsequent flow charts, FIG. 4 and FIG. 5, are show in a particular order for purposes of illustration, in other embodiments, one or more steps may be performed in a different order or overlapping in time, in series or in parallel, or one or more steps may be omitted or added, or changed in some combination of ways.

In step 201 the event generator process 127 detects initial operation of the device, such as during power up or movement to a cell of a different base station or access point; and control passes to step 203. In step 203 an event geolocation message is sent for receipt by the content service system. The geolocation even message indicates the geographic location of the mobile device, determined in any manner known in the art. For example, in some embodiments, the mobile terminal 120 includes a Global Positioning System (GPS) receiver and logic to determine the geographic location of the mobile terminal. In some embodiments, an identifier for a base station (not shown) in network 105, which receives communications from the mobile terminal 120, is sent to the mobile terminal 120, and is included in the geolocation event message. This information can be used to locate the mobile terminal in the geographic vicinity of the base station having that particular identifier. In some embodiments, the user's device is a wired node, e.g., other host 140, and geolocation is based on an identifier for provider edge equipment used to connect the node to the network 105.

In some embodiments, the geolocation event message, and other event messages described below, are sent directly to a content service module 133 (or played content tracker process 137), e.g., using a network address and port number for the destination process. In such embodiments, data is received that indicates the network address and port number of the content service module. Any method may be used to receive this data. For example, in various embodiments, the data is included as a default value in software instructions, is received as manual input from a network administrator on the local or a remote node, is retrieved from a local file or database, or is sent from a different node on the network, either in response to a query or unsolicited, or the data is received using some combination of these methods.

In certain embodiments, the event messages are sent to a message service 110. In a separate step, described below with reference to FIG. 4, the content service module 133, or played content tracker process 137, registers with the message service 110 to receive event messages from the user's mobile device (e.g., mobile terminal 120).

In some embodiments, geographic location is not used; and step 203 is omitted.

In step 211, it is determined whether the start of play of some particular content, e.g., a particular song, is detected. Play of previously stored content is sometimes called playback of content. The term “playback” when used as a noun, refers to the act of playing or playing back. If no content is played before the device is powered off, then the process ends without sending any additional event messages of interest to the content service system 130. If, however, the start of play of some particular content is detected, the process sends the play event, per step 213. It is contemplated that any method may be used to determine the start of play of content. For example, in some embodiments, the event generator process may monitor commands on an internal bus of the device to detect the retrieval of content from storage or the issuance of a command to a media play process.

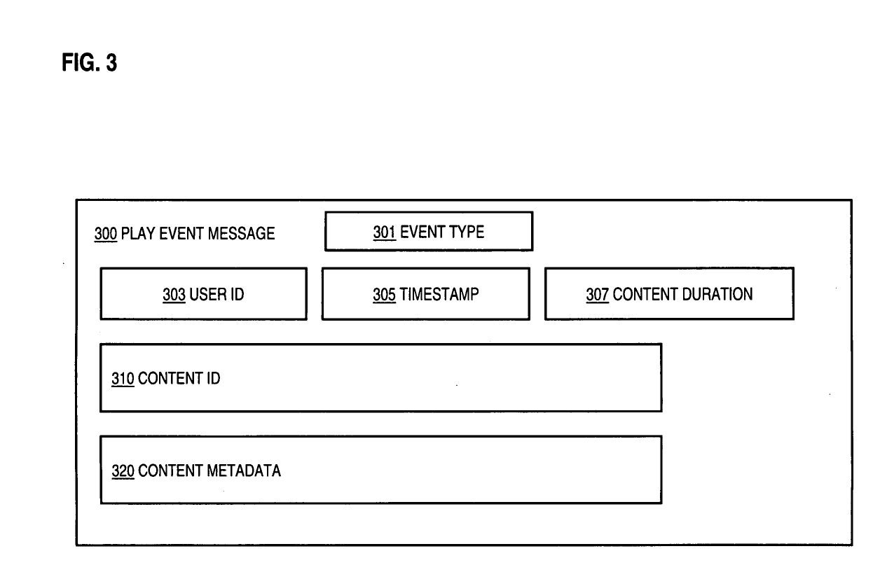

As described above, in various embodiments, the message is sent to a message service 110 or to a process in the content service system 130, such as content service module 133 or played content tracker 137. An example play event message is described in more detail below with respect to FIG. 3.

In step 221, it is determined whether a stop playback event is detected; various approaches may be used to determine the stopping of playback. For example the event generator process 127 may monitor commands on an internal bus of the device to detect the issuance of a stop command to a media play process. If a stop playback event is detected, control passes to step 223. In step 223 a stop playback event message is sent. The stop playback event message is different from other play event messages. In some embodiments, stop playback event messages are not sent, and step 221 or step 223 or both are omitted.

In step 231, it is determined whether a reporting time interval has passed since the last play event message was sent. Any reporting interval may be used. For example, in some embodiments, a reporting interval is about 50 seconds. A reporting interval that is not too short is useful to avoid generating an excess of event messages that can diminish the bandwidth or other network resources between the playing device and the content service system 130 or message service 110. In some embodiments, a reporting interval is not used and steps 231 and 233, described next, are omitted. If a reporting interval has not passed, or is not used, control passes back to step 221 to detect a stop play event.

If it is determined in step 231 that a reporting interval has passed, to the process, as in step 233, sends a play event message that is not a start play event message or a stop play event message.

FIG. 3 is a diagram of a play event message, according to one embodiment. In the illustrated embodiment, the play event message 300 includes a event type field 301, user identifier (ID) field 303, a timestamp field 305, a content duration field 307, a content identifier (ID) field 310 and a content metadata field 320.

The event type field 301 holds data that indicates the type of event being reported in the message, such as a geolocation event, a start playback event, a stop playback event, and a play event that is neither start playback event nor a stop playback event. In some embodiments, such as embodiments with only play events that are neither start playback events nor a stop playback events, or embodiments that use only start play events, the event type field 301 can be omitted.

The user ID field 303 holds data that indicates a particular user of multiple users of the content service system 130. Any user ID may be used, such as a node identifier for the device used for playback, a user supplied name, an email address, or an ID assigned to a user who registers with the content service system 130. In some embodiments, a user ID is inferred from a node identifier for the device used for playback included in a lower protocol header, and such a field serves as the user ID field 303. In some embodiments, the user ID field 303 is omitted.

The timestamp field 305 holds data that indicates when the event occurred on the device that plays the content. In some embodiments, the timestamp field 305 is omitted.

The content duration field 307 holds data that indicates the time needed to play the content fully for appreciation by a human user. This field 307, in certain embodiments, can be omitted.

The content ID field 310 holds data that uniquely identifies the content being played. In some embodiments, the field holds data that indicates a name of the content and a name of an artist who generated the content, such as a song title and singer name. In some embodiments, the content ID field 310 holds data that indicates a unique tag for the content, such as a value for a retrieval key for the content from the content database 132. The content ID field is not omitted because it is used to form a playlist. In a geolocation event message, the content ID field is replaced by a geolocation value field, that holds data that indicates a geographic location for the device on which the content is played.

The content metadata field 320 holds metadata for the content being played, such as an album identifier for an album that includes the song. In some embodiments, the content metadata field 320 includes the content duration field 307. In some embodiments, the content metadata field 320 is omitted.

FIG. 4 is a flowchart of a process 400 for tracking played content in the content service module, according to one embodiment. In some embodiments, the process to track what content is played (called the played content tracker 137 hereinafter) is separate from and parallel to the content service module 133.

In step 401, the played content tracker 137 registers with the message service 110 to receive play event messages, including any start playback event messages and stop playback event messages. In some embodiments, such as embodiments that include location of play in the playlist, the played content tracker 137 also registers to receive geolocation event messages. In certain embodiments in which messages are sent directly from the event generator 127 to the played content tracker 137, the message service 110 is not used, and step 401 is omitted.

In step 411, it is determined whether an event message is received. If so, then, in step 413, the event is stored, for example, in event data structure 138 on content database 132. The event data structure 138 accommodates some or all of the data in fields depicted in FIG. 3. The event data structure 138 comprises at least an event type field, a timestamp field and an event value field. The event value field holds the content ID from a play event message and the geographic location from a geolocation event message. In certain embodiments, the time stamp in the event data structure 138 is the same as the timestamp in field 305. By way of example, in some embodiments in which the timestamp field 305 is omitted from the event message, the timestamp stored in the event data structure 138 indicates the time that the event message was received by the played content tracker 137. In one embodiment, a timestamp is provided by the message service 110 and stored in the timestamp field in event data structure 138.

In step 431, it is determined whether the event just stored is a play event. If the process determines that the event is the play event, then, in step 433, it determines whether the event message indicates new content is being played. Any method may be used to indicate that new content is being played. In some embodiments, it is determined that the play event message indicates new content is being played if the event type indicated in event type field 301 is a start playback event. In some embodiments, in which a start playback event type is not used, it is determined that the play event message indicates new content is being played if the content ID indicated in the content ID field 310 is different from the current content ID indicated in a previous play event message.

If it is determined that the event message indicates new content is being played, then, n step 435, the play duration to fully playback the new content is determined. Any method may be used to determine the duration for full playback, called content duration hereinafter. In some embodiments, the content duration is included in the event message in content duration field 307 or in the content metadata field 320. In various embodiment, the content duration field 307 or the content metadata field 320, or both, are omitted. In one embodiment, the content ID indicated in the content ID field 310 is used to retrieve metadata for the content from the metadata data structure 135 in the content database 132; and the content duration is determined based on the metadata retrieved from the metadata data structure 135.

A threshold duration that indicates a user's desire or interest in the played content is determined based on the content duration. Content played for at least the threshold duration is added to a playlist, such as a play history for the user. Thus, in some embodiments, the threshold duration is determined during step 435. In one embodiment, the threshold duration is a constant fraction (or percentage X) of the content duration. In many embodiments, it is considered that the user has expressed sufficient interest in content to add that content to the playlist, if the user plays the content for more than a threshold percentage of, e.g., about 50%. In other embodiments, a threshold percentage is set in a range between about 30% and about 70% of the content duration. To accommodate some very long content durations, in one embodiment, the threshold is the lesser of a percentage X of the content duration and some fixed time, e.g., one minute. A song added to a user's play history is said to be “scrobbled.” Thus, in some embodiments, the threshold duration is called a “scrobbling threshold duration,” and the percentage X is called the “scrobbling threshold percentage” or, simply, “scrobbling threshold.” In other approaches, a song is scrobbled when the user starts playing it. In contrast to the other approaches, in the illustrated embodiments, a song is scrobbled only if the song is played for at least the threshold duration, or all the way through

In step 437, the current event is marked “now playing.” Any method may be used to mark the current event as now playing, such as a bit in the stored event data structure. According to one embodiment, a dynamic object in computer memory is created called a now_playing_event. The now_playing_event object includes a parameter for each of the fields associated with a play event, such as a content ID, a timestamp, and a song duration. The event is marked “now playing” by setting the now_playing_event object equal to the corresponding values for the current play event message. If a stop play event message is received, then the now_playing_event object is set to NONE.

If it is determined in step 433 that the event message indicates content being played is not new content, or after step 437, then, in step 441, it is determined whether an elapsed play time for the content is less than the content duration.

The elapsed play time of playing the content is the difference between the current time (such as a timestamp associated with the current play event message) and the timestamp associated with the earliest previous play event message for the same content ID (without different content ID indicated in intervening event messages from the same playing device) or the previous play event of a different content ID. In some embodiments, the sequence of steps forms a loop that involves: (1) receiving first event data that indicates the particular content and a start time at which play of the particular content began; (2) receiving second event data that indicates the particular content and a later time during continuous play of the particular content; and (3) determining the elapsed play time based on the first event data and the second event data. As used herein, an event message indicates time either by a timestamp included in the message or by the time that the event message is received.

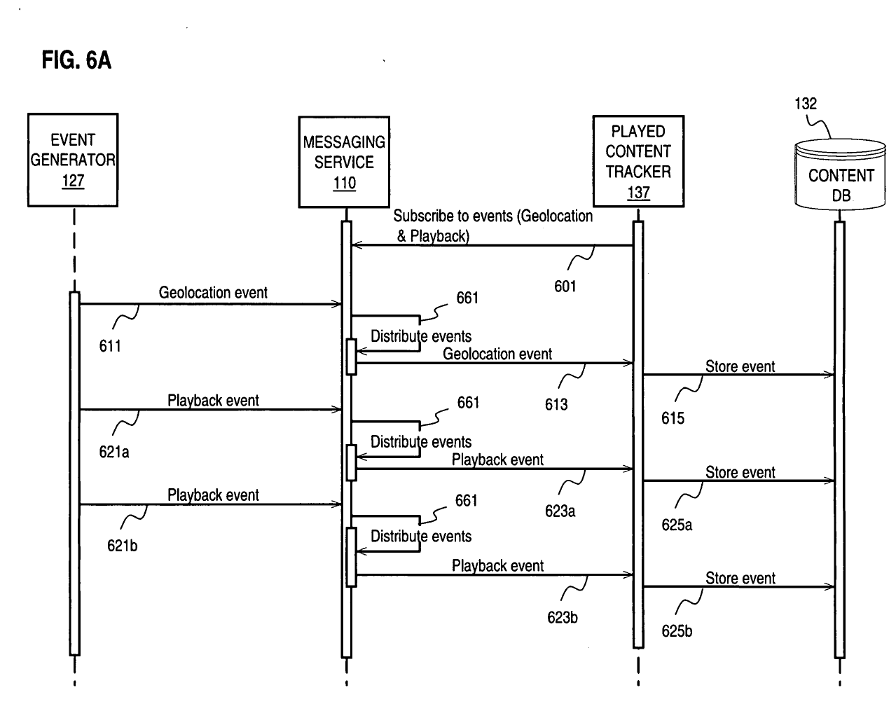

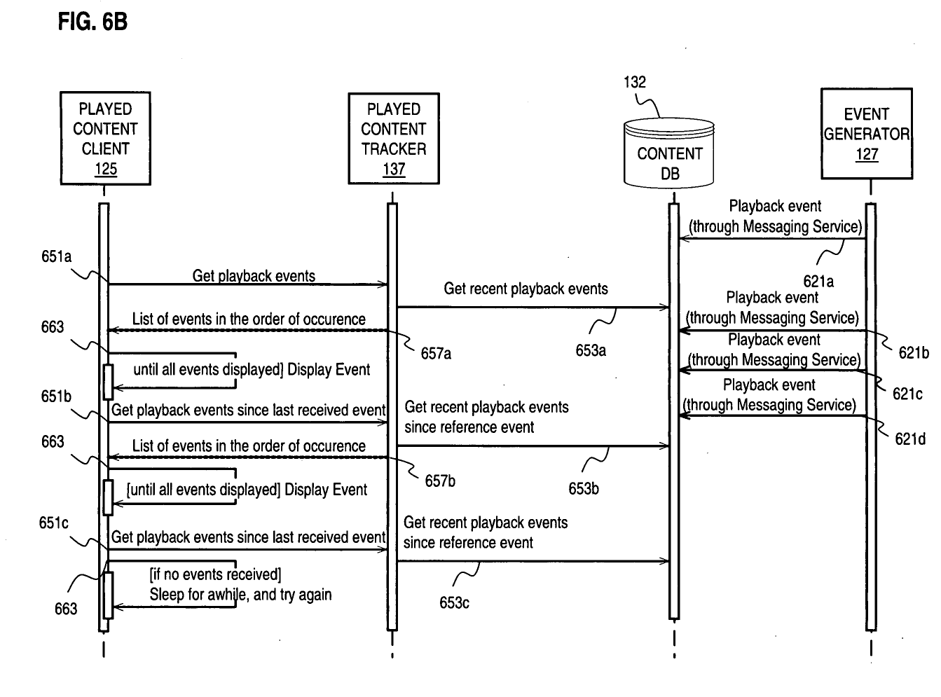

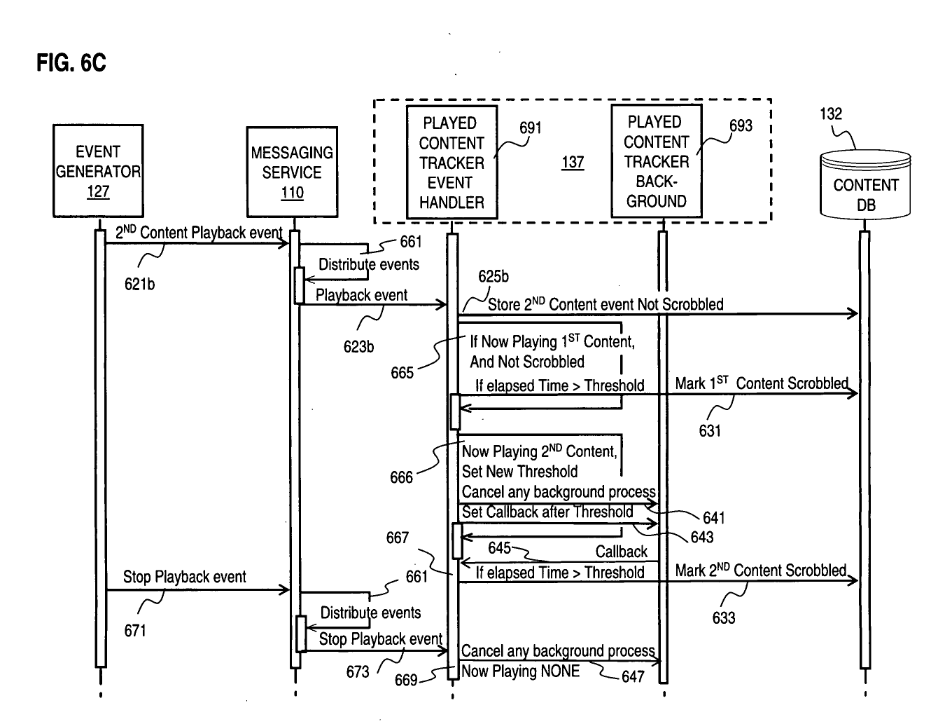

In some embodiments, in which only one event message is sent at the start of playing particular content, it is assumed that the previous content is played from the time associated with its start message until the time associated with the current start play message of the current content. In some embodiments, the sequence of steps forms a loop that involves: (1) receiving first event data that indicates first content and a start time at which play of the particular content began; (2) receiving second event data that indicates second content and a later time for play of the second content; and (3) determining the elapsed play time based on the first event data and the second event data. In embodiments using only start play event messages, the second content is different from the first content, and the second event data indicates the later time at the start of play of the second content. In embodiments that use a reporting interval, the second content may be the same as the first content, and the later time is a later time during continuous play of the first content. In some embodiments, the elapsed time is determined by the time between the start of play of particular content associated with a playback event message and the time of a callback from a background process, if no intervening playback event message is received. This embodiment is described in more detail below with reference to FIG. 6C.

If it is determined, in step 441, that elapsed play time for playing the content is less than the content duration, then it is determined, in step 445, whether the elapsed play time is less than the threshold duration (e.g., the scrobbling threshold duration). If so, then no data that indicates adding the content ID to the playlist is written to the database 132, i.e., the content is not scrobbled, and the process continues with determining whether the next message is an event message, in step 411. If, however, the elapsed play time is not less than the threshold duration (i.e., the elapsed play time is equal to or greater than the threshold duration), then content is indicated in a playlist, during step 447. For example, if the elapsed play time of a song is greater than the scrobbling threshold, then the song is scrobbled.

In step 447, the content ID is added to the playlist, such as by adding the content ID to the play history for the user. Any method may be used to add the content ID to a playlist. In one embodiment, a logical parameter called now_playing_event.Scrobbled is set to “true” in the now_playing_event object. In some embodiments, one or more events stored in the event data structure 138 include a scrobbled flag of one or more bits. In these embodiments, the scrobbled flags in event records associated with the current value of the content ID are set to a value to indicate the content ID associated with the event belongs on a playlist, such as a play history for the user associated with the event. In these embodiments, the scrobbled bits constitute the playlists data structure 139 depicted in the event data structure 138. In some embodiments, a separate playlists data structure 139 is constructed with only one entry for scrobbled content, regardless of the number of events associated with playing that content. In some of these embodiments, the playlists data structure 139 includes one entry for each time the content is scrobbled, regardless of how many events are involved, so as to represent a complete play history of scrobbled content for a user.

If it is determined, in step 441, that elapsed play time for playing the content is not less than the content duration, then the content has played all the way through, and the content is added to the playlist, during step 447. The process continues with determining whether the next message is an event message, in step 411, described above.

If it is determined in step 411 that an event message is not received, then the process determines if a request for a playlist is received, in step 421. For example a HTTP Get message is received from a Social Music API client 155, which is not an event message. In step 421, it is determined whether the message is a request for a playlist. If so, the playlist is sent in step 425. For example, for purposes of illustration, it is assumed that the HTTP Get message received from a Social Music API client 155 requests a playlist for a particular user.

In step 425, the playlist is sent in response to the request. In some embodiments, all the events stored in the event data structure 138 for the user are sent. In some embodiments only the events on the playlist are sent. In some embodiments, a separate playlist without duplicate entries is sent.

In step 427 it is determined whether the played content tracker process should stop. If so, the process ends. Otherwise it is determined whether the next message received is an event message, in step 411 as described above.

If it is determined that the message is not a request for a playlist, then, in step 423, other tasks are performed in response to the message. For example, a web page is returned in response to an HTTP request. Then it is determined in step 427 whether to stop the process.

FIG. 5 is a flowchart of a process 500 for forwarding event messages in a message service module, according to one embodiment. An advantage of this process is that the content player and the played content tracker need not be active and on line at the same time. Furthermore, the mobile terminal 120 can move from one network gateway to another and the played content tracker can readily get the event messages sent without doing additional processing.

In step 501, the message service 110 receives registration data from the played content tracker 137. The registration data indicates event types of interest and where they should be sent, e.g., a network address and port to which events of interest should be forwarded. In some embodiments, the registration information indicates a set of users or devices from which events are of interest.

In step 503, an event generator process 127 in the user device that plays content (e.g., mobile terminal 120) registers with the message service 110 to process events generated by the process 127.

In step 511, an event message is received from the event generator process 127 on the device with the content player. In step 513, it is determined whether the event is a type of interest for the played content tracker process 137. If not, the process forwards the other event messages in step 521. In step 523, it is determined if conditions are satisfied to stop forwarding messages. If so, the process ends. Otherwise the next event message is received in step 511, as described above.

If it is determined in step 513 that the event is a type of interest for the played content tracker process 137, then, in step 515, an event message, based on the event message received from the event generator, is sent to the played content tracker process 137 that registered in step 501.

FIG. 6A is a time sequence diagram that illustrates a sequence of messages and processes for forwarding events, according to one embodiment. Time increases downward in this diagram. A network process on the network is represented by a thin vertical box. A message passed from one process to another is represented by horizontal arrows. A step performed by a process is indicated by a box or looping arrow overlapping the process at a time sequence indicated by the vertical position of the box or looping arrow.

The processes represented in FIG. 6A are the event generator 127 on mobile terminal 120, the message service 110, the played content tracker 137 and the content database 132. A register message 601 is sent from the played content tracker 137 to the message service 110 to request that certain events received at the message service 110 be forwarded to the played content tracker 137. For example, the played content tracker requests that geolocation events and playback events from a mobile device be forwarded.

The event generator 127 detects conditions for sending a geolocation event (e.g., the mobile device has been turned on or has moved to a cell of a new base station) and sends a geolocation event message 611. In process 661, the message service 110 distributes this event message to all subscribers for it, including the played content tracker 137. The message service 110 forwards geolocation event message 613, based on received message 611, to the played content tracker 137. The played content tracker 137 issues message 615 to store the geolocation event in the content database 132. For example, the played content tracker 137 in the Social Music service issues a command to the database interface 153 to store one or more fields of the geolocation event message.

Similarly, the event generator 127 detects conditions for sending a playback event (e.g., a user of the mobile terminal starts playing a particular song) and sends playback event messages 621a and 621b. In process 661, the message service 110 distributes these playback event messages, in turn, to all subscribers for them, including the played content tracker 137. The message service 110 forwards playback event message 623a and 623b, based on received messages 621a and 621b, respectively, to the played content tracker 137. The played content tracker 137 issues messages 625a and 625b to store the playback events in the content database 132, such as by issuing database interface commands to store one or more fields of the playback event messages 623a and 623b.

FIG. 6B is a time sequence diagram that illustrates a sequence of messages and processes for requesting stored playback events, according to one embodiment. FIG. 6B includes a played content client 125 among the processes exchanging messages.

Messages 621a, 621b, are as described above for FIG. 6A. Additional playback event messages are indicated by messages 621c and 621d. The played content tracker 137 receives a request 651a for playback events from a played content client 125 (e.g., played content client 125b on other host 140). The played content tracker 137 exchanges one or more messages 653a with the content database 132 (e.g., through the database interface 153) to get recent events stored in the event data structure 138. Typically, the request and retrieval is for events associated with a particular user. One or more messages 657a with the recent events in order of occurrence (e.g., an event history) are sent to the played content client 125 from the played content tracker 137. In some embodiments, all events are included in messages 657a. In some embodiments, only events added to a playlist are included in messages 657a, e.g., only scrobbled songs are returned. In process 663, the returned events, or some portion thereof, are displayed by the played content client 125.

Similarly, another request 651b for playback events is received from a played content client 125. This request includes a reference event, e.g., the last event received in the messages 657a. The played content tracker 137 exchanges one or more messages 653b with the content database 132 to get recent events stored since the reference event. One or more messages 657ba are sent, with the most recent events since the reference event in order of occurrence (e.g., an event history), to the played content client 125 from the played content tracker 137. In some embodiments, all events since the reference event are included in messages 657b. In some embodiments, only events added to a playlist since the reference event are included in messages 657b, e.g., only scrobbled songs are returned. In process 663, the returned events, or some portion thereof, are displayed by the played content client 125.

When a request is made before new events are recorded, there is nothing to display. For example, request 651c for playback events is received from a played content client 125. The played content tracker 137 exchanges one or more messages 653c with the content database 132 to get recent events stored since the reference event. There are none, so no response is sent. During step 663, the played content client 125 sleeps for a while and then sends another request later, if no response is received from the played content tracker 137.

FIG. 6C is a time sequence diagram that illustrates a sequence of messages and processes for marking stored events, according to one embodiment. The played content tracker process 137 is here divided into an event handler process 691 and a background process 693. The other processes exchanging messages, and messages 621b, 623b and 625b are as described above for FIG. 6A.

It is assumed for purposes of illustration that playback messages are sent only upon the start of playing content, and that the playback event 623b is the second received by the played content tracker 137 and indicates play was started for second content. Playback event message 623a (see FIG. 6B) indicates play was started for first content. It is further assumed that the first content and the second content are different, for purposes of illustration. The data associated with the playback event message 623b is stored in the content database 132, e.g., in event data structure 138 without being added to a playlist, e.g., the scrobble flag bits are set to “false.”

In this example, during step 665, before the now_playing_event object is set to indicate the second content, the now_playing_event object still indicates the first event received in message 623a, indicating start of play of the first content. The event handler 691 determines if the now_playing_event object is not yet flagged as scrobbled. If not yet flagged, the elapsed time is determined from the start time of the first content (e.g., the time when the first playback event message 623a was received) to the current time (e.g., the current system time or the time when the second playback event message 623b was received). If the elapsed time is greater than the Threshold, then message 631 is issued to mark the first content event record in the database as scrobbled, e.g., a database interface write command is issued to set the scrobbled flag bits to “true.” The Threshold is based on the duration of the now_playing_event object, which is the content duration of the first content.

During step 666, the now_playing_event object is set to indicate the second content and a new Threshold is determined based on the content duration of the second content. If the first event (indicating the first content) was not scrobbled by this step, it will not be scrobbled at all. In some embodiments, the background process 693 is responsible for notifying the event handler 691 when the threshold duration is reached from the start time of the now_playing_event object. Thus, in these embodiments, the background process 693 will force the scrobble test even if no new playback message is received. During step 666, any outstanding background processes are canceled, e.g., a background callback process for the first event is canceled if the second event is received before the threshold duration for the first event. The call to cancel background processes is indicted by the message 641 sent from the event handler 691 to the background process 693. A background callback process is then initiated for the second event, e.g., to notify the event handler 691 when the new Threshold duration is reached after the start time of the second content, as indicated by the time associated with the second event. The call to the background process to callback the event handler is indicted by the message 643 sent from the event handler 691 to the background process 693.

For purposes of illustration, it is assumed that a callback message 645 is received at the event handler 691 from the background process 693. In response, a new elapsed time is determined during step 667. The elapsed time is determined from the start time of the now_playing_event object (e.g., the time when the second playback event message 623b was received) to the current time (e.g., the current system time). If the elapsed time is greater than the new Threshold, then message 633 is issued to mark the second content event record in the database as scrobbled, e.g., a database interface write command is issued to set the scrobbled flag bits to “true.”

In some embodiments, a stop playback event message is also used. When a stop playback event is sent in message 671 and forwarded as message 673, the event handler process 691 performs step 669. In step 669, the event handler process 691 marks the most recent content as not now playing. For example, the now_playing_event object is set to NONE. Any background process is canceled by the message 647 sent from the event handler to the background process during step 669. Thus, if the callback message 645 is not received before the stop message 673, a callback message will not be received. In this circumstance, the entry in the event data structure for the second content is not added to a playlist, e.g., its scrobbled flag bits are not set to “true,” and thus remain “false”.

The processes described herein for tracking content playback may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such example hardware for performing the described functions is detailed below.

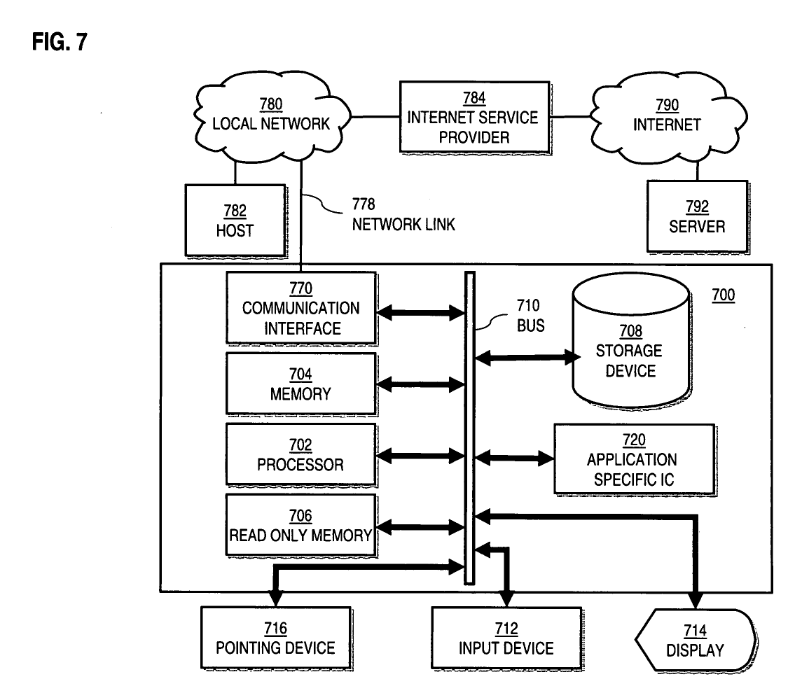

FIG. 7 illustrates a computer system 700 upon which an embodiment of the invention may be implemented. Computer system 700 includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information. The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a transmission medium such as a cable or carrier wave, or any other medium from which a computer can read. Information read by a computer from computer-readable media are variations in physical expression of a measurable phenomenon on the computer readable medium. Computer-readable storage medium is a subset of computer-readable medium which excludes transmission media that carry transient man-made signals.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790. A computer called a server host 792 connected to the Internet hosts a process that provides a service in response to information received over the Internet. For example, server host 792 hosts a process that provides information representing video data for presentation at display 714.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

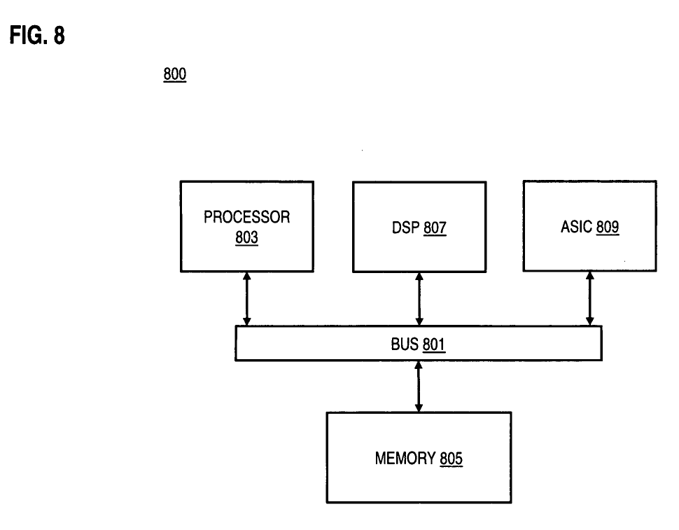

FIG. 8 illustrates a chip set 800 upon which an embodiment of the invention may be implemented. Chip set 800 is programmed to carry out the inventive functions described herein and includes, for instance, the processor and memory components described with respect to FIG. 8 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-word signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein. The memory 805 also stores the data associated with or generated by the execution of the inventive steps.

FIG. 9 is a diagram of example components of a mobile station (e.g., handset) capable of operating in the system of FIG. 1A, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the station include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In the example embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The MCU 903 delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-readable storage medium carrying one or more sequences of one or more instructions which, when executed by one or more processors, cause the one or more processors to at least perform the following steps:
determining whether elapsed play time for particular content is greater than a threshold duration; and
based on the determination that elapsed play time is greater than the threshold duration, initiating storage of data that indicates the particular content is to be indicated in a list of played content.

2. A computer-readable storage medium of claim 1, wherein the one or more processors are caused to perform steps further comprising:
determining a full duration for playing the particular content; and
determining the threshold duration based on the full duration.

3. A computer-readable storage medium of claim 1, wherein the one or more processors are caused to perform steps further comprising:
receiving first event data that indicates first content and a start time at which play of the first content began;
receiving second event data that indicates second content and a later time for play of the second content; and
determining the elapsed play time based on the first event data and the second event data.

4. A computer-readable storage medium of claim 3, wherein the first event data and the second event data are received from a message service on a first host that is different from a second host of a process that plays content in response to a choice by a user.

5. A computer-readable storage medium of claim 4, wherein the one or more processors are caused to perform steps further comprising initiating subscribing to the message service to forward event data sent by the second host.

6. A computer-readable storage medium of claim 1, wherein the particular content is audio data for a particular song.

7. A computer-readable storage medium of claim 1, wherein the playlist is associated with a particular user who chose to play the particular content.

8. An apparatus comprising a processor and a memory storing executable instructions that if executed cause the apparatus to at least perform the following:
determining whether elapsed play time for particular content is greater than a threshold duration; and
based on the determination that elapsed play time is greater than the threshold duration, initiating storage of data that indicates the particular content is to be indicated in a list of played content.

9. An apparatus of claim 8, wherein the processor and the memory are further configured to initiate:
determining a full duration for playing the particular content; and
determining the threshold duration based on the full duration.

10. An apparatus of claim 8, wherein the processor and the memory are further configured to initiate:
receiving first event data that indicates the first content and a start time at which play of the first content began;
receiving second event data that indicates second content and a later time for play of the second content; and
determining the elapsed play time based on the first event data and the second event data.

11. An apparatus of claim 10, wherein the first event data and the second event data are received from a message service on a first host that is different from a second host of a process that plays content in response to a choice by a user.

12. An apparatus of claim 11, wherein the processor and the memory are further configured to initiate subscribing to the message service to forward event data sent by the second host.

13. An apparatus of claim 8, wherein the particular content is audio data for a particular song.

14. An apparatus of claim 8, wherein the playlist is associated with a particular user who chose to play the particular content.

16. A method comprising:
determining whether elapsed play time for particular content is greater than a threshold duration; and
based on the determination that elapsed play time is greater than the threshold duration, initiating storage of data that indicates the particular content is to be indicated in a list of played content.

17. A computer-readable storage medium carrying one or more sequences of one or more instructions which, when executed by one or more processors, cause the one or more processors to at least perform the following steps:
initiating playing first content selected by a user;
initiating sending, to a content tracking service, first event data that indicates the first content and a start time at which play of the first content began; and
initiating sending, to the content tracking service, second event data that indicates second content and a later time for play of the second content.

18. An apparatus comprising a processor and a memory storing executable instructions that if executed cause the apparatus to at least perform the following:
initiating playing first content selected by a user;
initiating sending, to a content tracking service, first event data that indicates the first content and a start time at which play of the first content began; and
initiating sending, to the content tracking service, second event data that indicates second content and a later time for play of the second content.

19. An apparatus of claim 18, wherein the apparatus is included in a handset configured to send the first event data and the second event data over a communication network that includes a wireless network.

20. A method comprising:
initiating playing first content selected by a user;
initiating sending, to a content tracking service, first event data that indicates the first content and a start time at which play of the first content began; and
initiating sending, to the content tracking service, second event data that indicates second content and a later time for play of the second content.
